(19) United States
(12) Patent Application Publication
(10) Pub. No.: US 2005/0219128 A1
(43) Pub. Date: Oct. 6, 2005

(54) Antenna radiator assembly and radio communications device

(76) Inventors: Yu Chee Tan, Singapore (SG); Yew Siow Tay, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/814,367

(22) Filed: Mar. 31, 2004

(51) Int. Cl. H01Q 1/24

(52) U.S. Cl. 343/702; 343/700 MS

(57) ABSTRACT

An antenna radiator assembly (45) comprising radio frequency communications circuitry (8,9) and a ground plane (40). There is a radio frequency radiator element (7) and a feed point electrically coupling the radio frequency radiator element (7) to the radio frequency communications circuitry (8,9), the feed point physically contacting the radio frequency radiator element (7) at a feed contact point (51). A first ground connector couples the radio frequency radiator element to the ground plane (40), the first ground connector electrically coupling the radio frequency radiator element (7) at a first ground contact point (53) A second ground connector selectively couples the radio frequency radiator element to the ground plane through a switching unit (22), the second ground connector electrically coupling the radio frequency radiator element (7) at a second ground contact point (56). The antenna radiator assembly (45) forms part of a radio communications device (1).

### FIELD OF THE INVENTION

This invention relates to an antenna radiator assembly and radio communications device including an antenna radiator assembly. The invention is particularly useful for, but not necessarily limited to, multi-band wireless communication devices with internal antennas.

### BACKGROUND OF THE INVENTION

Wireless communication devices often require multi-band antennas for transmitting and receiving radio communication signals often called Radio Frequency (RF) signals. For example, network operators providing service on a GSM system in a 900 MHz frequency band typically used in Asia also use a DCS system in a 1800 MHz frequency band typically used in Europe. Accordingly, GSM wireless communication devices, such as cellular radio telephones, should have dual band antennas to be able to effectively communicate at least at both of these frequencies. Also, in certain countries service providers operate on 850 MHz or 1900 MHz frequency bands

Current consumer requirements are for compact wireless communication devices that typically have an internal antenna instead of an antenna stub that is visible to the user. Small cellular telephones now require a miniaturized antenna comprising an antenna radiator structure coupled to a ground plane, the ground planes being typically formed on or in a circuit board of the telephone. The antenna must be able to cover multiple frequency bands to, for instance, accommodate the 850 MHz, 900 MHz, 1800 Mhz and 1900 Mhz bands whilst being compact.

Internal antenna radiator structures, using a radiator element in the form of a micro-strip internal patch antenna, are considered advantageous in several ways because of their compact lightweight structure, which is relatively easy to fabricate and produce with precise printed circuit techniques or metal stamping techniques capable of integration on printed circuit boards. Most known internal patch antennas tend to have a narrow bandwidth, unless a thick but low permittivity and low conductivity dielectric substrate or mount is employed. The resulting thick substrate or mount affects antenna characteristics and limits their use in many applications, particularly in handheld mobile communication devices with severe space and weight constraints.

Conventional patch antenna assemblies have natural resonant frequencies or modes for RF and microwave applications. However, there are shortcomings when using natural resonant frequencies for antenna assemblies as they are dependent upon at least the following antenna assembly factors a) the shape and dimensions of the patch; b) the shape and dimensions of the ground plane; c) the location of the feed point contact on the patch; d) the location of the ground plane contact on the patch. Once the above factors are fixed, the resonant frequencies for the antenna assembly are also fixed. It is therefore difficult to provide a compact and economic multi-band antenna assembly more specifically a quad-band antenna assembly, using a single patch antenna for use in a radio communications device.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

### SUMMARY OF THE INVENTION

According to one aspect of the invention there is provided a radio communications device comprising: a processor; radio frequency communications circuitry coupled to said processor; a ground plane; a radio frequency radiator element; a feed point electrically coupling the radio frequency radiator element to the radio frequency communications circuitry, the feed point physically contacting the radio frequency radiator element at a feed contact point of the radio frequency radiator element; a first ground connector electrically coupling the radio frequency radiator element to the ground plane, the first ground connector electrically coupling the radio frequency radiator element at a first ground contact point of the radio frequency radiator element; a switching unit; and a second ground connector selectively electrically coupling the radio frequency radiator element to the ground plane through the switching unit, the second ground connector electrically coupling the radio frequency radiator element at a second ground contact point of the radio frequency radiator element, wherein in use the switching unit selectively couples the frequency radiator element to the ground plane depending upon desired operating frequency bands for the radio frequency radiator element.

According to another aspect of the invention there is provided an antenna radiator assembly comprising: radio frequency communications circuitry; a ground plane; a radio frequency radiator element; a feed point electrically coupling the radio frequency radiator element to the radio frequency communications circuitry, the feed point physically contacting the radio frequency radiator element at a feed contact point of the radio frequency radiator element; a first ground connector electrically coupling the radio frequency radiator element to the ground plane, the first ground connector electrically coupling the radio frequency radiator element at a first ground contact point of the radio frequency radiator element; a switching unit; and a second ground connector selectively electrically coupling the radio frequency radiator element to the ground plane through the switching unit, the second ground connector electrically coupling the radio frequency radiator element at a second ground contact point of the radio frequency radiator element.

Suitably, the first ground contact point is proximal to a first edge of the radio frequency radiator element.

Preferably, the second ground contact point is proximal to a second edge of the radio frequency radiator element.

The feed contact point and second ground contact point are preferably coupled at respective locations on the radio frequency radiator element so that when the second ground connector selectively couples the passive radiator element to the ground plane through the switching unit, the impedance of the radio frequency radiator element is substantially impedance matched to the radio frequency communications circuitry. Further, the feed contact point and first ground contact point are preferably coupled at respective locations on the radio frequency radiator element so that when the second ground connector is electrically isolated from the ground plane by the switching unit, and the first ground connector is electrically coupling the radio frequency radiator element to the ground plane, the impedance of the radiator element is substantially impedance matched to the radio frequency communications circuitry.

Suitably, the first ground connector provides a permanent electrical coupling of the radio frequency radiator element to the ground plane, wherein when the second ground connector electrically couples the radio frequency radiator element to the ground plane through the switching unit, the first ground connector also electrically couples radio frequency radiator element to the ground plane.

Preferably, when the second ground connector is electrically isolated from the ground plane by the switching unit, the radio frequency radiator element provides for a first resonant frequency of substantially 850 MHZ and a second resonant frequency of 1,800 MHZ.

Suitably, when the second ground connector is electrically coupled to the ground plane by the switching unit, the radio frequency radiator element provides for a third resonant frequency of substantially 900 MHZ and a fourth resonant frequency of 1,900 MHZ.

Preferably, when the second ground connector is electrically isolated from the ground plane by the switching unit, the ground plane has a longer effective length than when the ground connector is electrically coupled to the ground plane by the switching unit. Also, when the second ground connector is electrically isolated from the ground plane by the switching unit, an effective length between the feed contact point and the ground plane is increased compared to when the second ground connector is electrically coupled to the ground plane by the switching unit.

Preferably, the switching unit is coupled to, and operatively controllable by, the radio communications circuitry.

According to another aspect of the invention there is provided an antenna radiator assembly comprising: radio frequency communications circuitry; a ground plane; a radio frequency radiator element; a feed point electrically coupling the radio frequency radiator element to the radio frequency communications circuitry, the feed point physically contacting the radio frequency radiator element at a feed contact point of the radio frequency radiator element; a first ground connector electrically coupling the radio frequency radiator element to the ground plane, the first ground connector electrically coupling the radio frequency radiator element at a first ground contact point of the radio frequency radiator element; a switching unit; and a plurality of further ground connectors selectively electrically coupling the radio frequency radiator element to the ground plane through the switching unit, the plurality of further ground connectors electrically coupling the radio frequency radiator element at respective ground contact points of the radio frequency radiator element.

Suitably, the first ground contact point is proximal to a first edge of the radio frequency radiator element.

Preferably, the respective ground contact points associated with the further ground connectors are proximal to a second edge of the radio frequency radiator element.

### BRIEF DESCRIPTION OF THE DRAWINGS

In order that the invention may be readily understood and put into practical effect, reference will now be made to preferred embodiments as illustrated with reference to the accompanying drawings in which:

FIG. 1 is a block diagram of a first embodiment of a radio communications device including an antenna radiator assembly in accordance with the present invention;

FIG. 2 is perspective view of the antenna radiator assembly of a first embodiment in accordance with the invention;

FIG. 3 is a plan view of part of the antenna radiator assembly of FIG. 2;

FIG. 4 is a plan view of part of the antenna radiator assembly of FIG. 2 illustrating one effective length of a ground plane

FIG. 5 is a plan view of part of the antenna radiator assembly of FIG. 2 illustrating another effective length of the ground plane;

FIG. 6 is a typical frequency response of the present invention;

FIG. 7 is a block diagram of a second embodiment of an antenna radiator assembly in accordance with the present invention; and

FIG. 8 is a plan view of a second embodiment illustrating part of an antenna radiator assembly of FIG. 7.

### DETAILED DESCRIPTION OF THE PREFERRED EMBODIMENTS OF THE INVENTION

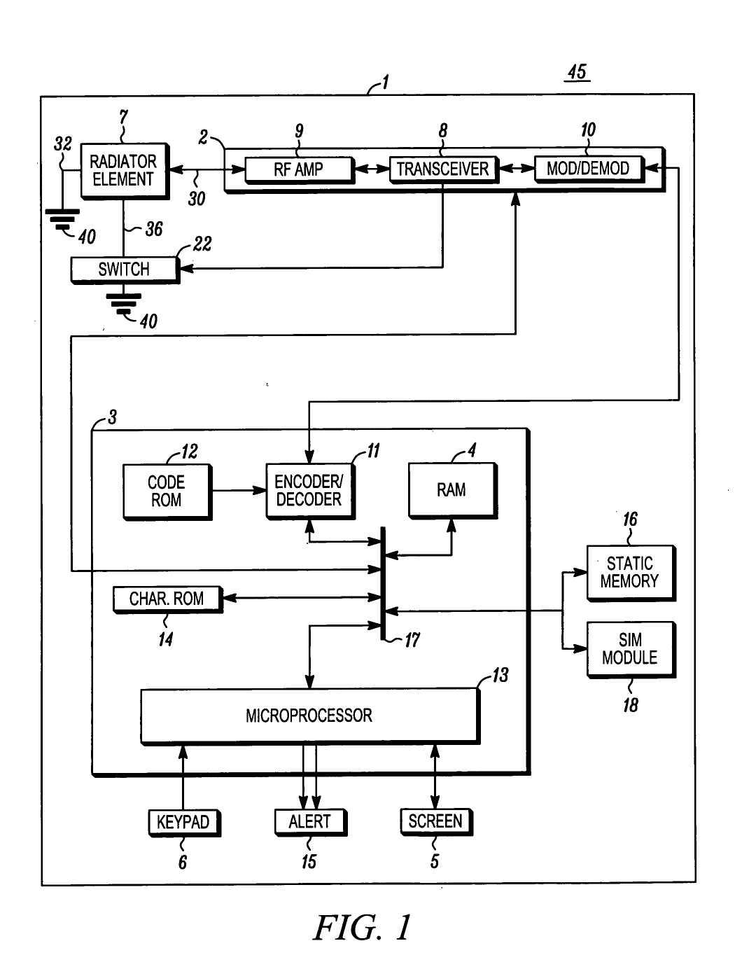

In the drawings, like numerals on different Figs are used to indicate like elements throughout. With reference to FIG. 1, there is illustrated a first preferred embodiment of a radio communications device in the form of a radio telephone 1 comprising radio frequency communications circuitry 2 coupled to be in communication with a processor 3. An input interface in the form of a screen 5 and a keypad 6 are also coupled to be in communication with the processor 3. As will be apparent to a person skilled in the art the screen 5 can be a touch screen thereby eliminating the need for the keypad 6.

The processor 3 includes an encoder/decoder 11 with an associated Read Only Memory (ROM) 12 storing data for encoding and decoding voice or other signals that may be transmitted or received by the radio telephone 1. The processor 3 also includes a micro-processor 13 coupled, by a common data and address bus 17, to the radio frequency communications circuitry 2, encoder/decoder 11, a character Read Only Memory (ROM) 14, a Random Access Memory (RAM) 4, static programmable memory 16 and a removable SIM module 18. The static programmable memory 16 and SIM module 18 each can store, amongst other things, selected incoming text messages and a telephone book database.

The micro-processor 13 has ports for coupling to the keypad 6, the screen 5 and an alert module 15 that typically contains a speaker, vibrator motor and associated drivers. The character Read only memory 14 stores code for decoding or encoding text messages that may be received by the communication circuitry 2, input at the keypad 6. In this embodiment the character Read Only Memory 14 also stores operating code (OC) for micro-processor 13. As will be apparent to a person skilled in the art the radio telephone 1 also has a speaker and microphone and other components (not shown).

The radio frequency communications circuitry 2 is has a transceiver 8 coupled to both a radio frequency amplifier 9 and a combined modulator/demodulator 10. There is also illustrated a radio frequency radiator element 7 that is directly coupled to the radio frequency amplifier 9 by a feed point 30. Thus, the feed point 30 provides for electrically coupling a radio frequency radiator element 7 to the radio frequency communications circuitry 2. There is also a first ground connector 32, a second ground connector 36 and a switching unit 22, the switching unit 22 being coupled to, and operatively controllable by, the transceiver 8 that forms part of the radio communications circuitry 2. The first ground connector 32 provides for electrically coupling the radio frequency radiator 7 to a ground plane 40 and the second ground connector 36 provides for selectively electrically coupling to the radio frequency radiator element 7 to the ground plane 40 through the switching unit 22. The radio frequency communications circuitry 2, ground plane 40, radio frequency radiator 7, feed point 30, switching unit 22, the first ground connector 32 and second ground connector form at least part of an antenna radiator assembly 45.

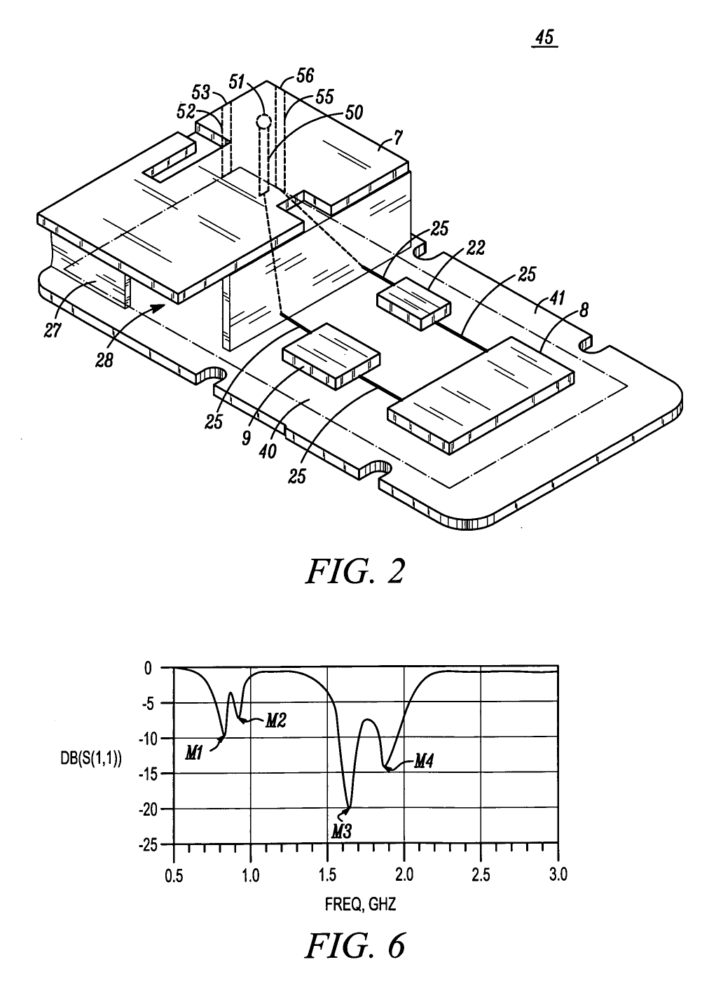

Referring to FIG. 2 there is illustrated a first preferred embodiment of the antenna radiator assembly 45 comprising a circuit board 41 supporting the radio frequency amplifier 9, the transceiver 8, switching unit 22 and a conductive plate (shown in phantom due to it being sandwiched in circuit board 41) providing part of the ground plane 40. There are also other typical components/modules (not shown for clarity) and other conductive plates combined forming the ground plane 40 that are mounted to or electrically coupled the circuit board 41. The radio frequency radiator element 7 is coupled to the transceiver 8 unit 2 through: a) the feed point 30, in the form of a spring loaded feed point pin 50 (shown in phantom); b) the radio frequency amplifier 9; and c) runners 25 (most runners on circuit board 41 are not shown). As illustrated, the feed point 30 is physically contacting the radio frequency radiator element 7 at a feed contact point 51 of the radio frequency radiator element 7.

The radio frequency radiator element 7 is also directly coupled to the ground plane 40 by the first ground connector 32 in the form of a coupling spring 52 (shown in phantom). As illustrated, the first ground connector 32 is electrically coupling the radio frequency radiator element 7 at a first ground contact point 53 of the radio frequency radiator element 7. Further, the second ground connector 36, in the form of a coupling spring 55 (shown in phantom), provides for selectively electrically coupling to the radio frequency radiator element 7 to the ground plane 40 through the switching unit 22. More specifically, the second ground connector 36 provides for electrically coupling of the radio frequency radiator element 7 to the ground plane 40 at a second ground contact point 56 of the radio frequency radiator element 7.

The radio frequency radiator element 7 is mounted to a dielectric mount 27 in the form housing 27 (typically formed from a dielectric plastics material) for housing a resonator cavity 28 within which typically resides a speaker (not shown).

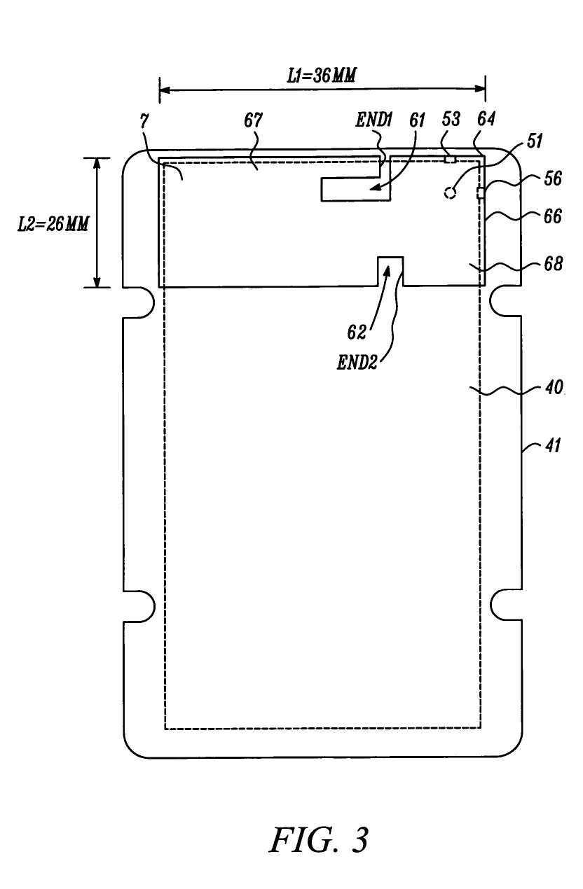

Referring to FIG. 3, part of the first preferred embodiment of the antenna radiator assembly 45 is shown in plan view. As illustrated, the radio frequency radiator element 7 is typically formed from flat planar conductive copper sheet with slots therein. In this specific embodiment the radio frequency radiator element 7 has two slots 61,62 that form two radiator element portions (described in more detail later), having respective open circuit ends at the approximate locations END1 and END2 Also, the first ground contact point 53 is proximal to a first edge 64 of the radio frequency radiator element 7. Similarly, the second ground contact point 56 is proximal to a second edge 66 of the radio frequency radiator element 7.

The feed contact point 51 and second ground contact point 56 are coupled at respective locations on the radio frequency radiator element 7 so that when the second ground connector 36 selectively couples the radio frequency radiator element to the ground plane 40 through the switching unit 22, the impedance Z2 of the radiator element is substantially impedance matched to the radio frequency communications circuitry 8. This is essentially achieved by impedance matching circuitry in the radio frequency amplifier 9. Further, the feed contact point 51 and first ground contact point 53 are coupled at respective locations on the radio frequency radiator element 7 so that when the second ground connector 36 is electrically isolated from the ground plane 40, by the switching unit 22, and the first ground connector is electrically coupling the active radiator element 7 to the ground plane 40, the impedance Z1 of the radio frequency radiator element 7 is substantially impedance matched to the radio frequency communications circuitry 8.

In this preferred embodiment, the first ground connector 32 provides a permanent electrical coupling of the active radiator element 7 to the ground plane 40. When the second ground connector 36 electrically couples the radio frequency radiator element to the ground plane 40 through the switching unit 22, the first ground connector also electrically couples radio frequency radiator element 7 to the ground plane 40.

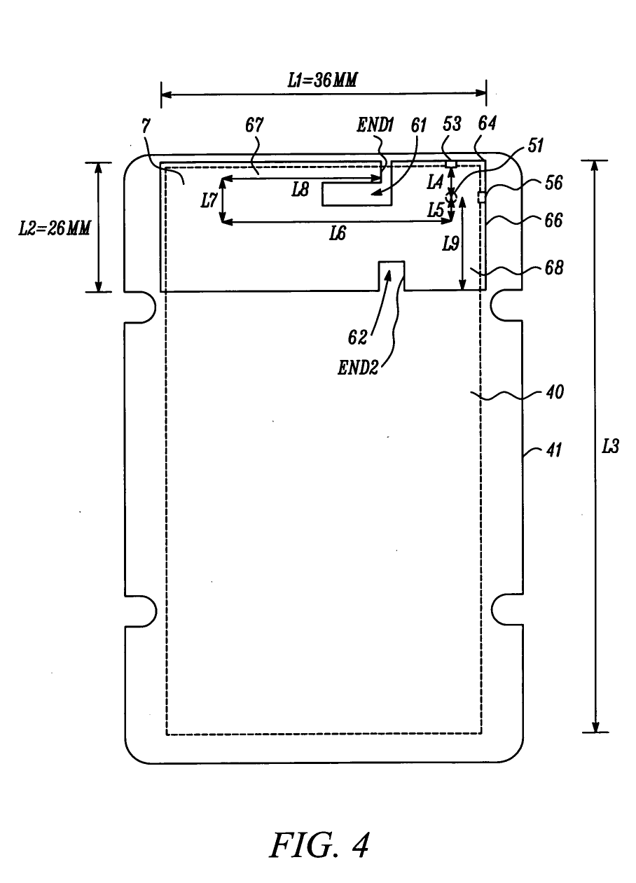

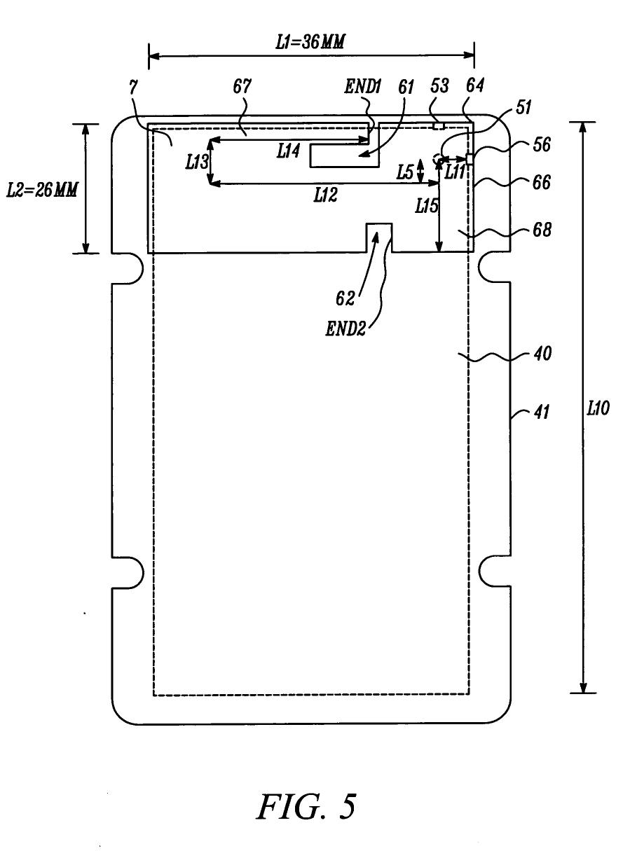

Referring to FIGS. 4 and 5 there is illustrated plan views of part of the antenna radiator assembly 45 identifying effective lengths of the ground plane 40. In these illustrations, when the second ground connector 36 is electrically isolated from the ground plane 40 by the switching unit 22, the ground plane 40 has a longer effective length L3 than an effective length L10 when the ground connector is electrically coupled to the ground plane by the switching unit 22. Also, when the second ground connector 36 is electrically isolated from the ground plane 40 by the switching unit 22, an effective length L4 between the feed contact point 30 and the ground plane 40 is increased compared to an effective length L11 when the second ground connector 36 is electrically coupled to the ground plane 40 by the switching unit 22.

The slots in the radio frequency radiator element 7 provides for the two radiator element portions 67,68 with their respective open circuit ends at the approximate locations END1 and END2. When the second ground connector 36 is electrically isolated from the ground plane 40 the radiator element portion 67 has a radiator element length REL1=L4+L5+L6+L7+L8; and the radiator element portion 68 has radiator element length REL2=L4+L9. Also, when the second ground connector 36 is electrically coupled to the ground plane 40 the radiator element portion 67 has a radiator element length REL3=L11+L5+L12+L13+L14; and the radiator element portion 68 has radiator element length REL4=L11+L15.

It should be noted that in this specification, the antenna radiator element 7 is commonly known as a patch or internal antenna and this antenna can be totally enclosed inside a housing of the radio communications device 1 it the antenna form part of a housing wall of the radio communications device 1.

As illustrated in FIG. 6, the first embodiment provides for four frequency bands. When the second ground connector 36 is electrically isolated from the ground plane 40, by the switching unit 22, the radio frequency radiator element 7 provides for a first resonant frequency m1 of substantially 850 MHZ and a second resonant frequency m2 of 1,800 MHZ. When the second ground connector 36 is electrically coupled to the ground plane 40 by the switching unit 22, the radio frequency radiator element 7 provides for a third resonant frequency m3 of substantially 900 MHZ and a fourth resonant m4 frequency of 1,900 MHZ. Hence, in use the invention advantageously provides for the switching unit 22 to selectively couple the frequency radiator element 7 to the ground plane 40 depending upon desired operating frequency bands (m1-m3, or m2-m4) for the radio frequency radiator element 7.

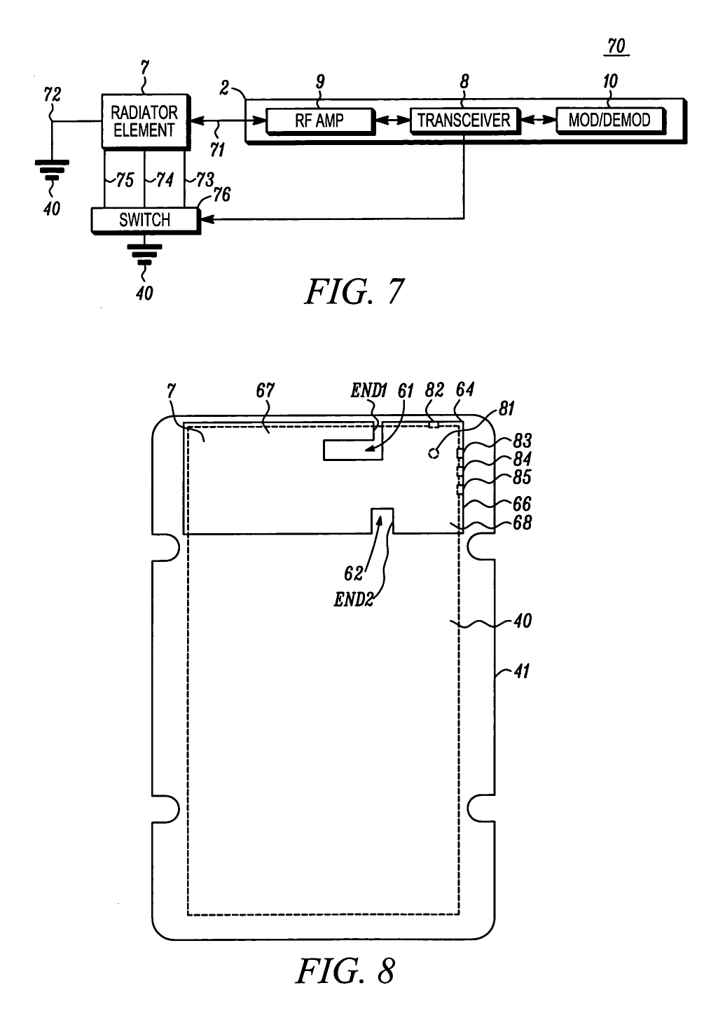

Referring to FIGS. 7 and 8 there is illustrated a second preferred embodiment of the antenna radiator assembly 70 in which the radio frequency radiator element 7 is directly coupled to the radio frequency amplifier 9 by a feed point 71. Thus, the feed point 71 provides for electrically coupling a radio frequency radiator element 7 to the radio frequency communications circuitry 2. There is also a first ground connector 72, a plurality of further ground connectors 73,74,75 and a switching unit 76, the switching unit 76 being coupled to, and operatively controllable by, the transceiver 8 that forms part of the radio communications circuitry 2. The first ground connector 72 provides for electrically coupling the radio frequency radiator 7 to the ground plane 40 and the further ground connectors 73,74,75 provide for selectively electrically coupling to the radio frequency radiator element 7 to the ground plane 40 through the switching unit 76.

The radio frequency communications circuitry 2, ground plane 40, radio frequency radiator 7, feed point 71, switching unit 76, the first ground connector 71 and further ground connectors form at least part of an antenna radiator assembly 70. Also, the first ground connector 72 has a first ground contact point 82 that is proximal to a first edge 64 of the radio frequency radiator element 7. Similarly, the further ground connectors 73,74,75 have respective ground contact points proximal to a second edge 66 of the radio frequency radiator element 7. As will be apparent to a person skilled in the art, the antenna radiator assembly 70 can be included in the radio communications device 1 and functions in a similar manner to that of the antenna radiator assembly 40.

Advantageously, the present invention provides for compact, economic multi band (quad-band) internal antenna radiator assembly and a radio communications device capable of operating at multiple specified bands. The detailed description provides a preferred exemplary embodiments only, and is not intended to limit the scope, applicability, or configuration of the invention. Rather, the detailed description of the preferred exemplary embodiments provide those skilled in the art with an enabling description only. It should be understood that various changes may be made in the function and arrangement of elements without departing from the spirit and scope of the invention as set forth in the appended claims.

1. A radio communications device comprising:
a processor;
radio frequency communications circuitry coupled to said processor;
a ground plane;
a radio frequency radiator element;
a feed point electrically coupling the radio frequency radiator element to the radio frequency communications circuitry, the feed point physically contacting the radio frequency radiator element at a feed contact point of the radio frequency radiator element;
a first ground connector electrically coupling the radio frequency radiator element to the ground plane, the first ground connector electrically coupling the radio frequency radiator element at a first ground contact point of the radio frequency radiator element;
a switching unit; and
a second ground connector selectively electrically coupling the radio frequency radiator element to the ground plane through the switching unit, the second ground connector electrically coupling the radio frequency radiator element at a second ground contact point of the radio frequency radiator element, wherein in use the switching unit selectively couples the frequency radiator element to the ground plane depending upon desired operating frequency bands for the radio frequency radiator element.

2. A radio communications device as claimed in claim 1, wherein the first ground contact point is proximal to a first edge of the radio frequency radiator element.

3. A radio communications device as claimed in claim 2, wherein the second ground contact point is proximal to a second edge of the radio frequency radiator element.

4. A radio communications device as claimed in claim 1, wherein the feed contact point and second ground contact point are coupled at respective locations on the radio frequency radiator element so that when the second ground connector selectively couples the passive radiator element to the ground plane through the switching unit, the impedance of the radio frequency radiator element is substantially impedance matched to the radio frequency communications circuitry.

5. A radio communications device as claimed in claim 1, wherein the feed contact point and first ground contact point are coupled at respective locations on the radio frequency radiator element so that when the second ground connector is electrically isolated from the ground plane by the switching unit, and the first ground connector is electrically coupling the radio frequency radiator element to the ground plane, the impedance of the radiator element is substantially impedance matched to the radio frequency communications circuitry.

6. A radio communications device as claimed in claim 1, wherein the first ground connector provides a permanent electrical coupling of the radio frequency radiator element to the ground plane, and wherein when the second ground connector electrically couples the radio frequency radiator element to the ground plane through the switching unit, the first ground connector also electrically couples radio frequency radiator element to the ground plane.

7. A radio communications device as claimed in claim 1, wherein when the second ground connector is electrically isolated from the ground plane by the switching unit, the radio frequency radiator element provides for a first resonant frequency of substantially 850 MHZ and a second resonant frequency of 1,800 MHZ.

8. A radio communications device as claimed in claim 7, wherein when the second ground connector is electrically coupled to the ground plane by the switching unit, the radio frequency radiator element provides for a third resonant frequency of substantially 900 MHZ and a fourth resonant frequency of 1,900 MHZ.

9. A radio communications device as claimed in claim 1, wherein when the second ground connector is electrically isolated from the ground plane by the switching unit, the ground plane has a longer effective length than when the ground connector is electrically coupled to the ground plane by the switching unit.

10. A radio communications device as claimed in claim 1, wherein when the second ground connector is electrically isolated from the ground plane by the switching unit, an effective length between the feed contact point and the ground plane is increased compared to when the second ground connector is electrically coupled to the ground plane by the switching unit.

11. A radio communications device as claimed in claim 1, wherein the switching unit is coupled to, and operatively controllable by, the radio communications circuitry.

12. An antenna radiator assembly comprising:
radio frequency communications circuitry;
a ground plane;
a radio frequency radiator element;
a feed point electrically coupling the radio frequency radiator element to the radio frequency communications circuitry, the feed point physically contacting the radio frequency radiator element at a feed contact point of the radio frequency radiator element;
a first ground connector electrically coupling the radio frequency radiator element to the ground plane, the first ground connector electrically coupling the radio frequency radiator element at a first ground contact point of the radio frequency radiator element;
a switching unit; and
a second ground connector selectively electrically coupling the radio frequency radiator element to the ground plane through the switching unit, the second ground connector electrically coupling the radio frequency radiator element at a second ground contact point of the radio frequency radiator element.

13. An antenna radiator assembly as claimed in claim 12, wherein the first ground contact point is proximal to a first edge of the radio frequency radiator element.

14. An antenna radiator assembly as claimed in claim 13, wherein the second ground contact point is proximal to a second edge of the radio frequency radiator element.

15. An antenna radiator assembly as claimed in claim 12, wherein the feed contact point and second ground contact point are coupled at respective locations on the radio frequency radiator element so that when the second ground connector selectively couples the passive radiator element to the ground plane through the switching unit, the impedance of the radio frequency radiator element is substantially impedance matched to the radio frequency communications circuitry.

16. An antenna radiator assembly as claimed in claim 12, wherein the feed contact point and first ground contact point are coupled at respective locations on the radio frequency radiator element so that when the second ground connector is electrically isolated from the ground plane by the switching unit, and the first ground connector is electrically coupling the radio frequency radiator element to the ground plane, the impedance of the radiator element is substantially impedance matched to the radio frequency communications circuitry.

17. An antenna radiator assembly as claimed in claim 12, wherein the first ground connector provides a permanent electrical coupling of the radio frequency radiator element to the ground plane, and wherein when the second ground connector electrically couples the radio frequency radiator element to the ground plane through the switching unit, the first ground connector also electrically couples radio frequency radiator element to the ground plane.

18. An antenna radiator assembly as claimed in claim 12, wherein when the second ground connector is electrically isolated from the ground plane by the switching unit, the radio frequency radiator element provides for a first resonant frequency of substantially 850 MHZ and a second resonant frequency of 1,800 MHZ.

19. An antenna radiator assembly as claimed in claim 18, wherein when the second ground connector is electrically coupled to the ground plane by the switching unit, the radio frequency radiator element provides for a third resonant frequency of substantially 900 MHZ and a fourth resonant frequency of 1,900 MHZ.

20. An antenna radiator assembly as claimed in claim 12, wherein when the second ground connector is electrically isolated from the ground plane by the switching unit, the ground plane has a longer effective length than when the ground connector is electrically coupled to the ground plane by the switching unit.

21. An antenna radiator assembly as claimed in claim 1, wherein when the second ground connector is electrically isolated from the ground plane by the switching unit, an effective length between the feed contact point and the ground plane is increased compared to when the second ground connector is electrically coupled to the ground plane by the switching unit.

22. An antenna radiator assembly as claimed in claim 1, wherein the switching unit is coupled to, and operatively controllable by, the radio communications circuitry.

23. An antenna radiator assembly comprising:
radio frequency communications circuitry; a ground plane;
a radio frequency radiator element;
a feed point electrically coupling the radio frequency radiator element to the radio frequency communications circuitry, the feed point physically contacting the radio frequency radiator element at a feed contact point of the radio frequency radiator element;
a first ground connector electrically coupling the radio frequency radiator element to the ground plane, the first ground connector electrically coupling the radio frequency radiator element at a first ground contact point of the radio frequency radiator element;
a switching unit; and
a plurality of further ground connectors selectively electrically coupling the radio frequency radiator element to the ground plane through the switching unit, the plurality of further ground connectors electrically coupling the radio frequency radiator element at respective ground contact points of the radio frequency radiator element.

24. An antenna radiator assembly as claimed in claim 23, wherein the first ground contact point is proximal to a first edge of the radio frequency radiator element.

25. An antenna radiator assembly as claimed in claim 24, the respective ground contact points associated with the further ground connectors are proximal to a second edge of the radio frequency radiator element.
